(19) United States
(12) Patent Application Publication
(10) Pub. No.: US 2003/0033085 A1
(43) Pub. Date: Feb. 13, 2003

(54) Mechanism for ensuring defect-free objects via object class tests

(76) Inventors: Humberto A. Sanchez II, Ft. Collins, CO (US); Richard Dale Harrah, Seattle, WA (US); Douglas P. Drees, Fort Collins, CO (US); Michael Scheetz, Fort Collins, CO (US); Miha Wang, Cupertino, CA (US); Roger William Kumpf, Cupertino, CA (US); Jenny Yu, Saratoga, CA (US); Carol Ann Krug-Graves, Monte Sereno, CA (US); Bapugouda Patil, Milpitas, CA (US); Mary Thomas Robb, Fort Collins, CO (US); Donald Suit, Fort Collins, CO (US); Warren I. Otsuka, Cambell, CA (US); Nagaraja Boranna, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/852,890

(22) Filed: May 10, 2001

(51) Int. Cl. G06F 19/00

(52) U.S. Cl. 702/1

(57) ABSTRACT

An embodiment of an object class test involves constructing objects from classes, developing a unit class test for each object, passing data into each object using the unit class test, and retrieving data from each object using the unit class test to determine if the object is functional. Accordingly, the object class test ensures that each object is functional before the objects are installed in a software development system. In addition, the object class test documents and implements source code necessary to produce standard output messages from the unit class test for each class, thus formalizing the object class test output into an easily parseable and human readable format.

### TECHNICAL FIELD

The present invention relates to system administration management, and, in particular, to Java class testing or other object testing.

### BACKGROUND

Object-oriented programming is continually gaining wider acceptance and usage throughout the software industry because of its benefits to the process and products of software engineering. Testing, especially during the integration phase, becomes increasingly important.

Unit tests, one of the corner stones of Extreme Programming, involve creating or downloading a unit test framework to be able to create automated unit test suites, and then testing all classes in the system. Unit tests are typically created before the creation of the code. Unit testing is a general good software development practice. However, unit testing only tests objects in isolation, i.e., unit testing does not test if different objects constructed from different classes can interact with each other.

Other industry articles and discussions merely discuss in an academic manner the idea of Java class tests. However, none of these articles or discussions provides any detail as to either output guidance or rules for documenting unit tests.

### SUMMARY

An embodiment of an object class test involves constructing objects from classes, developing a unit class test for each object, passing data into each object using the unit class test, and retrieving data from each object using the unit class test to determine if the object is functional. Accordingly, the object class test ensures that each object is functional before the objects are installed in a software development system. In addition, the object class test documents and implements source code necessary to produce standard output messages from the unit class test for each class, thus formalizing the object class test output into an easily parseable and human readable format. For example, if the data retrieved matches the data passed in, the unit class test returns a “pass” result regarding the particular object. Otherwise, the test returns a “failure” result.

### DESCRIPTION OF THE DRAWINGS

The preferred embodiments of the present invention will be described in detail with reference to the following figures, in which like numerals refer to like elements, and wherein:

FIG. 1 illustrates a computer network system with which the present invention may be used;

FIG. 2 illustrates the relationships between the user, role, node, tool and authorization objects;

FIG. 3 is a block diagram of an exemplary server used to implement the present invention;

FIG. 4 is a flow chart of a first embodiment of JCT;

FIG. 5 is a flow chart of a second embodiment of JCT;

FIG. 6 is a flow chart of a third embodiment of JCT; and

FIG. 7 is a flow chart of a fourth embodiment of JCT.

### DETAILED DESCRIPTION

Java class tests (JCT) document and implement source code necessary to produce standard output from unit tests for each ServiceControl Manager (SCM) Java class, thus formalizing the Java class test output into an easily parseable and human readable format. The JCT described below can be used for any type of objects and object classes in any other programming languages in addition to the Java programming language.

An SCM module multiplies system administration effectiveness by distributing the effects of existing tools efficiently across managed servers. The phrase “ServiceControl Manager” is intended as a label only, and different labels can be used to describe modules or other entities having the same or similar functions.

In the SCM domain, the managed servers (systems) are referred to as “managed nodes” or simply as “nodes”. SCM node groups are collections of nodes in the SCM module. They may have overlapping memberships, such that a single node may be a member of more than one group.

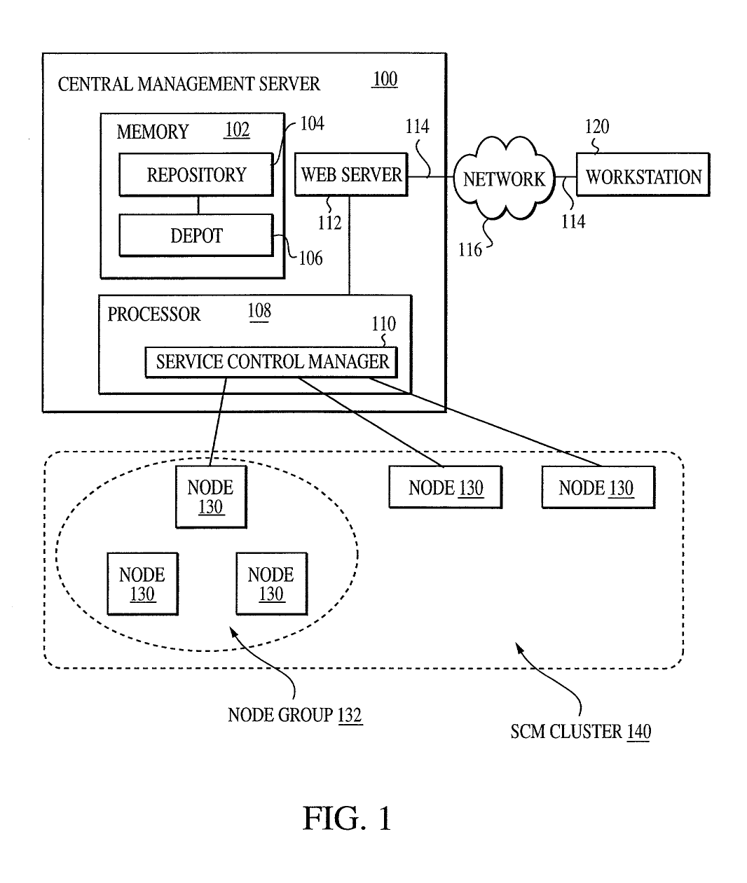

FIG. 1 illustrates a computer network system with which the present invention may be used. The network system includes an SCM 110 running on a Central Management Server (CMS) 100 and one or more nodes 130 or node groups 132 managed by the SCM 110. The one or more nodes 130 and node groups 132 make up an SCM cluster 140. For a more detailed description of an exemplary SCM, see ServiceControl Manager Technical References HP® part number: B8339-90019, available from Hewlett-Packard Company, Palo Alto, Calif., which is incorporated herein by reference and which is also accessible at <http://www.software.hp.com/products/scmg>.

The CMS 100 can be implemented with, for example, an HP-UX 11.x server running the SCM 110 software. The CMS 100 includes a memory 102, a secondary storage device (not shown), a processor 108, an input device (not shown), a display device (not shown), and an output device (not shown). The memory 102 may include computer readable media, RAM or similar types of memory, and it may store one or more applications for execution by processor 108, including the SCM 110 software. The secondary storage device may include computer readable media, a hard disk drive, floppy disk drive, CD-ROM drive, or other types of non-volatile data storage. The processor 108 executes the SCM software and other application(s), which are stored in memory or secondary storage, or received from the Internet or other network 116. The input device may include any device for entering data into the CMS 100, such as a keyboard, key pad, cursor-control device, touch-screen (possibly with a stylus), or microphone. The display device may include any type of device for presenting a visual image, such as, for example, a computer monitor, flat-screen display, or display panel. The output device may include any type of device for presenting data in hard copy format, such as a printer, and other types of output devices include speakers or any device for providing data in audio form. The CMS 100 can possibly include multiple input devices, output devices, and display devices.

The CMS 100 itself may be required to be a managed node, so that multi-system aware (MSA) tools may be invoked on the CMS. All other nodes 130 may need to be explicitly added to the SCM cluster 140. Alternatively, the CMS 100 may be part of the SCM cluster 140.

Generally, the SCM 110 supports managing a single SCM cluster 140 from a single CMS 100. All tasks performed on the SCM cluster 140 are initiated on the CMS 100 either directly or remotely, for example, by reaching the CMS 100 via a web connection 114. Therefore, the workstation 120 at which a user sits only needs a web connection 114 over a network 116, such as the Internet or other type of computer network, to the CMS 100 in order to perform tasks on the SCM cluster 140. The CMS 100 preferably also includes a centralized data repository 104 for the SCM cluster 140, a web server 112 that allows web access to the SCM 110 and a depot 106 that includes products used in the configuring of nodes 130. A user interface may only run on the CMS 100, and no other node 130 in the SCM module may execute remote tasks, access the repository 104, or any other SCM operations.

Although the CMS 100 is depicted with various components, one skilled in the art will appreciated that this server can contain additional or different components. In addition, although aspects of an implementation consistent with the present invention are described as being stored in memory, one skilled in the art will appreciated that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the CMS 100 to perform a particular method.

A central part of the SCM module 110 is the ability to execute various management commands or applications on the one or more nodes simultaneously. The commands or applications may need to be encapsulated with an SCM tool, which is typically used to copy files and/or execute commands on the target nodes 130. The SCM tool may run simple commands such as bdf (1) or mount (1M), launch single system interactive applications such as System Administration Manager (SAM) or Glance, launch multi-system aware applications such as Ignite/UX or Software Distributor (SD), or perform other functions. The tool may be defined using either an SCM tool definition language through command line interface (CLI) or an SCM-provided graphical user interface (GUI).

There are two general types of tools: single-system aware (SSA) tools and multi-system aware (MSA) tools. SSA tools may run on a node 130 and may only affect the operation of that node 130. To run SSA tools on multiple target nodes 130, the SCM module 110 may execute the tools on each target node 130. In addition to executing commands or launching applications, SSA tools may copy files from the CMS 100 to the target nodes 130. Files may only be copied from the CMS 100 to the managed nodes 130 in this exemplary embodiment, not from the nodes 130 back to the CMS 100.

MSA tools may run on a single node 130 but may be able to operate on multiple other nodes 130. MSA tools are applications that execute on a single node but can detect and contact other nodes to accomplish their work and this contact is out of the control of the SCM module 110. This type of application may need to have a list of nodes 130 passed as an argument at runtime. A node 130 where the application will execute may need to be specified at tool creation time, not at runtime. The target nodes 130 selected by the user may be passed to an MSA tool via Mx₁₃ TARGETS environment variables (described later). MSA tools may not copy files to either the manager node 100 or to the target nodes 130 in this exemplary embodiment. Therefore, an execution command string may be required for MSA tools.

An SCM user may be a user that is known to the SCM module 110 and has some privileges and/or management roles. An SCM role, which is an expression of intent and a collection of tools for accomplishing that intent, typically defines what the user is able to do on the associated nodes 130 or node groups 132, e.g., whether a user may run a tool on a node 130. Typically, in order to start the SCM module 110 or execute any SCM tools, the user may need to be added to the SCM module 110 and authorized either via the GUI or the command line interface (CLI). All SCM module 110 operations may be authorized based on the user's SCM authorization configuration, and/or whether or not the user has been granted SCM trusted user privilege.

The SCM user may, depending upon the roles assigned, manage systems via the SCM module 110. In addition, the user may examine an SCM log, and scan the group and role configurations. When the SCM user runs a tool, the result may be an SCM task. The SCM module 110 typically assigns a task identifier for every task after it has been defined and before it is run on any target nodes 130. This identifier may be used to track the task and to look up information later about the task in an SCM central log.

An SCM trusted user is an SCM user responsible for the configuration and general administration of the SCM cluster 140. The trusted user is typically a manager or a supervisor of a group of administrators whom a company trusts, or other trusted individual. The capabilities of the trusted user include, for example, one or more of the following: creating or modifying a user's security profile; adding, modifying or deleting a node or node group; tool modification; and tool authorization. The granting of these privileges implies a trust that the user is responsible for configuring and maintaining the overall structure of the SCM module 110.

An SCM authorization model supports the notion of assigning to users the ability to run a set of tools on a set of nodes. An authorization object is an association that links a user to a role on either a node or a node group. Each tool may belong to one or more roles. When users are given the authority to perform some limited set of functionality on one or more nodes, the authorization is done based upon roles and not on tools. The role allows the sum total of functionality represented by all the tools to be divided into logical sets that correspond to the responsibilities that would be given to the various administrators. Accordingly, there are different roles that may be configured and assigned with authorization. For example, a backup administrator with a “backup” role may contain tools that perform backups, manage scheduled backups, view backup status, and other backup functions. On the other hand, a database administrator with a “database” role may have a different set of tools. When a user attempts to run a tool on a node, the user may need to be checked to determine if the user is authorized to fulfill a certain role on the node and if that tool contains the role. Once a user is assigned an authorization, the user gains access to any newly created tools that contain the role. In the example given above, the backup administrator may be assigned the “backup” role for a group of systems that run a specific application. When new backup tools are created and added to the “backup” role, the backup administrator immediately gains access to the new tools on the systems.

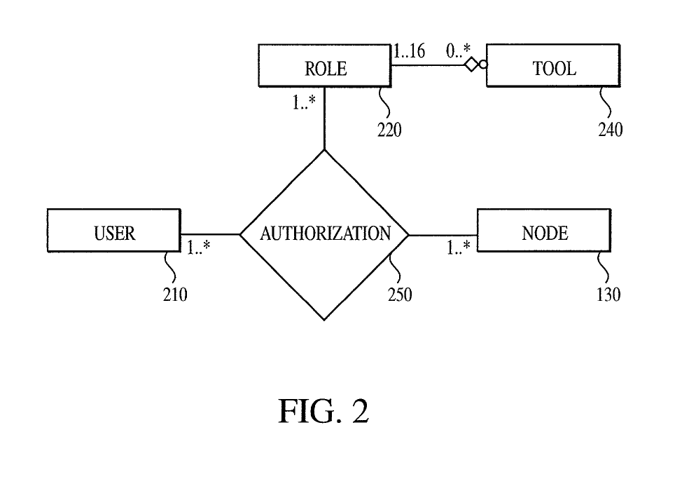

FIG. 2 illustrates the relationships between user 210, role 220, node 130, tool 240, and authorization 250 objects. User objects 210 represent users 210, role objects 220 represent roles 220, node objects 130 represent nodes 130, tool objects 240 represent tools 240, and authorization objects 250 represent authorizations 250. However, for the purpose of this application, these terms are used interchangeably. Each authorization object 250 links a single user object 210 to a single role object 220 and to a single node object 130 (or a node group object 132). Each role object 220 may correspond to zero or more tool objects 240, and each tool object 240 may correspond to one or more role objects 220. Each user object 210 may be assigned multiple authorizations 250, as may each role object 220 and each node object 130. For example, Role 1 may contain Tools 1-N, and User 1 may be assigned Roles 1-M by the authorization model on Node 1. Consequently, User 1 may run Tools 1-N on Node 1, based upon the role assigned, Role 1.

Table 1 illustrates an example of a data structure for assigning tools 240 and commands specified in the tools 240 to different roles 220. Table 2 illustrates an example of a data structure for assigning the roles 220 to different users 210 on different nodes 130.

TABLE 1

| | | Commands and |
|---|---|---|
| Roles | Tools | Applications |
| Role 1 | Tools 1-N | Commands 1-L |
| . . . | . . . | . . . |
| Role n | Tools 1-Nn | Commands 1-Ln |

TABLE 2

| Users | Assigned Roles | Assigned Nodes |
|---|---|---|
| User 1 | Roles 1-M | Nodes 1-x |
| . . . | . . . | . . . |
| User n | Roles 1-M | Nodes 1-x |

Although FIG. 2 shows a node authorization, a similar structure exists for a node group 132 authorization. The SCM authorization model may be deployed by using node group 132 authorizations more often than node 130 authorizations. This model makes adding new nodes simpler because by adding a node 130 to an existing group 132, any authorizations associated with the group 132 may be inherited at run-time by the node 130.

The authorization model for determining if a user may execute a tool 240 on a set of nodes 130 may be defined by an “all or none” model. Therefore, the user 210 must have a valid authorization association for each target node 130 to execute the tool 240. If authorization does not exist for even one of the nodes 130, the tool execution fails.

The SCM cluster 140 may also include security features to secure transactions that transmit across the network. All network transactions may be digitally signed using a public or private key pair. The recipient of network transmissions may be assured of who the transmission came from and that the data was not altered in the transmission. A hostile party on the network may be able view the transactions, but may not counterfeit or alter them.

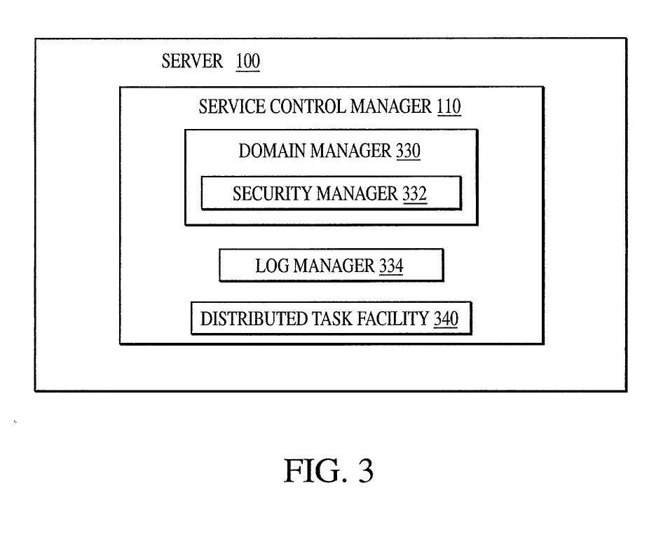

Referring to FIG. 3, the CMS 100 may include a domain manager 330, a log manager 334, and a distributed task facility (DTF) 240. The domain manager 330 is the “brain” of SCM module 110 and may be connected to the repository 104 for storage of the definitions of all the objects.

The DTF 340 may execute tasks by passing the task definitions and information to agents running on the managed nodes 130. The DTF 340 is the “heart” of all task execution activity in that all of the execution steps must go through the DTF 340. The DTF 340 typically obtains an authorized runnable tool from the domain manager 330 through a client, distributes the tool execution across multiple nodes 130, and returns execution results to the clients and to the user 210.

An integral part of the SCM functionality may be the ability to record and maintain a history of events, by logging both SCM configuration changes and task execution events through the log manager 334. The log manager 334 may manage a log file and take log requests from the DTF 340, the graphical user interface, and the command line interface, and write the requests to the SCM log file. SCM configuration changes may include adding, modifying and deleting users and nodes in the SCM module 110, and creating, modifying and deleting node groups 132 and tools 240. An example of task execution events may include details and intermediate events associated with the running of a tool 240. An example of task execution is described in United States patent application of Lister, Sanchez, Drees, and Finz, Ser. No. 09/813,562, entitled “Service Control Manager Tool Execution”, and filed on Mar. 20, 2001, which is incorporated herein by reference. The details that are logged may include the identity of the user 210 who launched the task, the actual tool and command line with arguments, and the list of target nodes 130. The intermediate events that are logged may include the beginning of a task on a managed node 130, and exceptions that occur in attempting to run a tool 240 on a node 130, and the final result, if any, of the task. The exit code, standard output (stdout) and standard error output (stderr), if exist, may also be logged.

A security manager 332, which is a subsection of the domain manager 330, typically guards the system security by checking whether the user 210 is authorized to run the tool 240 on all of the nodes 130 requested, i.e., whether the user 210 is assigned the roles 220 associated with the tool 240 on all of the nodes 130, and whether the necessary roles 220 are enabled on a particular tool 240.

Java classes are pieces of functionality within a software development system, such as the SCM cluster 140. SCM Java classes may include user classes, user manager classes, tool manager classes, role manager classes, node manager classes, node group manager classes, security manager classes, and other classes. A JCT is a self executing unit-by-unit test that uses different test methods to ensure that each SCM Java class is functional before the classes are installed in the software development system. The same or an equivalent JCT can also be used for testing object classes implemented in other types of programming languages.

Objects may be constructed from the classes by implementing a sequence of code to execute various class methods. For example, a user object may be constructed from the user class to include different parameters, such as a user identification (ID), a user name, a user location, a user telephone number, and other parameters. These parameters may be passed in the user object, for example, by a set method or as part of object construction. The set method may change the internal structure or representation of an object through a common interface. The set method is typically coupled with a get method that retrieves data passed in.

Likewise, a user manager object may be constructed from the user manager class, a tool manager object may be constructed from the tool manager class, a role manager object may be constructed from the role manager class, a node manager object may be constructed from the node manager class, a node group manager object may be constructed from the node group manager class, and a security manager object may be constructed from the security manager class.

The JCT may then run accessor methods to retrieve certain pieces of data to determine if whatever returned matches the data passed in. An example may be a get name method for the user object, which asks for the user name. If the user name returned by this method matches the user name passed in, the user object has been self-executed and tested as in working condition with respect to this parameter. Similarly, a get user ID method, a get user location method, a get user telephone number method may be run to test these parameters. If all the parameters have been tested as working, a more advanced system test, such as a high level system test, may be utilized to determine if different classes, such as the user class, the user manager class, the tool manager class, the role manager class, the node manager class, the node group manager class, and the security manager class, can interact with each other.

From high level system tests that test big granularity of functionality to the unit JCTs, there may be multiple passes, i.e., multiple permutations of task flow. The JCTs may include multiple test methods to cover the different permutations of task flow for a single object. For example, if there are three sectorial ways of installing a sequence of codes to construct an object, the JCT may contain three unit tests to cover the three passes. However, in cases where certain passes have a low likelihood of occurrence, the JCT may be written to cover only 75-80% of the different permutations of task flow, instead of 100%.

Objects may need to add more functionality. When the new functionality is developed for an object, the JCTs may be updated to ensure that the new functionality's basic components are operational before the new functionality is installed into the software development system.

For example, an object that represents the repository 104 may rely on an underlying functionality provided by an operator. The underlying functionality, typically developed by another operating system with the same interfaces, may need to be integrated into the system. Instead of testing the functionality after integration with the system, the JCTs may be used to ensure that the basic components of the underlying functionality are operational before the integration. If, for example, there are 99 tests, and 98 tests work on a given day with only one failure, the object that represents the repository 104 may be determined as working well. Users can determine any desired level of accuracy of the functionality. For example, for some applications a 90% passing level may be acceptable, and for other applications any higher level or any lower level may be acceptable. The JCT provides an indication of an accuracy level, and that level can be used for any purpose. Accordingly, before the object that represents the repository 104 is integrated with the rest of the system on the new platform, the operator may already know how well the object codes work.

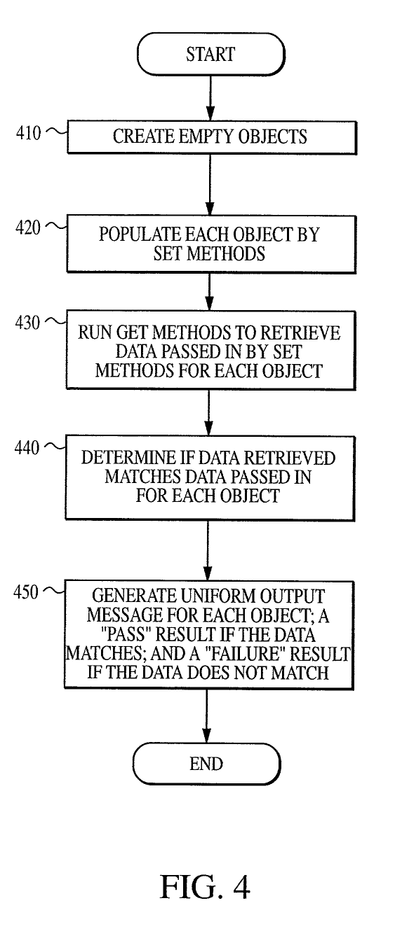

FIGS. 4, 5, 6, and 7 illustrate various embodiments of the JCT. These methods may be implemented, for example, in software modules for execution by processor 108.

As shown in FIG. 4, a first embodiment of the JCT may involve constructing objects by creating empty objects, step 410, and populating each object with data by set methods, step 420. The JCT may then execute all the alternative tasks to determine all the states that the objects may have, and run get methods to retrieve data passed in by the set methods for each object, step 430. If the data returned by the get methods matches the data passed in by the set methods, step 440, the test returns a “pass” result regarding the particular object, step 450. Otherwise, the test returns a “failure” result, step 450.

The “pass” and “failure” signals may place easily recognizable and standard output in test log files. The standard output messages enable an easy automation of a lookup process to count and measure the number of test successes and failures. Additionally, the standard output messages are easily parseable, making it easy to automate the collection of specific failures for later analysis.

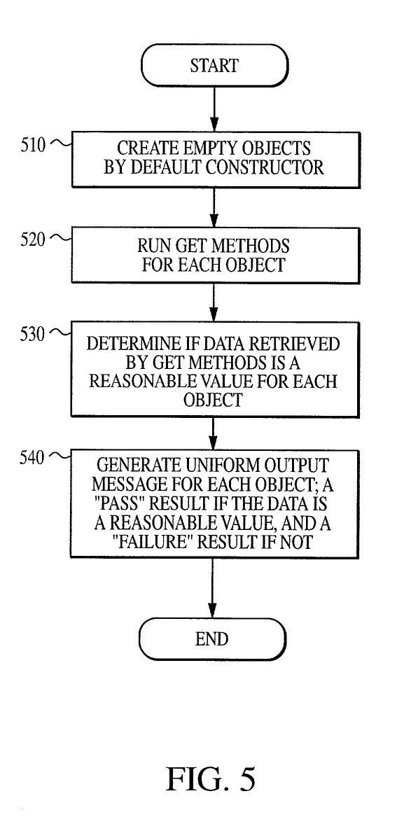

FIG. 5 illustrates a second embodiment of the JCT, involving default constructors that create empty objects. After an empty object is created by a default constructor, step 510, a get method may be run against the empty object, step 520, to test if the method will return a data with a reasonable value instead of aborting the test, step 530. A reasonable value may be any value that signals the object is an empty object. For example, when a default constructor creates an empty user object with no name and a get user ID method is run against the user object, the get method may return, for example, a minus one, signaling that the data returned is not a legal user ID. So long as the get method returns a reasonable value, the test returns a “pass” result, step 540. Otherwise, the test returns a “failure” result, step 540. The “pass” and “failure” signals may place easily recognizable and standard output in the test log files for future reference.

The following is an example of a source code routine of the JCT illustrated in FIG. 5.

//

**********************************************************************
**

/**

Test the MxUser class.

**/
//

**********************************************************************
**

public static void testUser ()

throws Exception

{

MxJctUtility.START_TEST_CASE (“MxUser”);
String testCase = “MxUser set methods”;
MxJctUtility.START_TEST (testCase);
// Test assigning values to the MxUser object
MxUser aUser = new MxUser ();
aUser.setName (new MxUserName (“hasii”));
aUser.setDescription (“This is my comment”);
aUser.setTrusted (true);
try
{

| MxJctUtility.MESSAGE (“Muxplex name: ” + aUser.getName ()); | |
|---|---|
| MxJctUtility.MESSAGE (“UID | : ” + aUser.getUID ()); |

MxJctUtility.MESSAGE (“Full name: ” + aUser.getFullName ());
MxJctUtility.MESSAGE (“Telephone:” + aUser.getTelephone ());
MxJctUtility.MESSAGE (“Office: ” + aUser.getOfficeLocation ());
MxJctUtility.MESSAGE (“Description: ”+aUser.getDescription ());

if (aUser.isTrusted ())

{

MxJctUtility.END_TEST_PASS (testCase);

}
else
{

MxJctUtility.END_TEST_FAIL (testCase);

}

}
catch (Exception e)
{

MxJctUtility.MESSAGE(“Caught an exception trying to get

info from a user.”);

MxJctUtility.MESSAGE (e.getMessage ());
MxJctUtility.END_TEST_FAIL (testCase);

}

}

The sample shown above illustrates how default objects are tested. In this example, public methods can be executed by anyone, and public data can be accessed by anyone. Static means that the code is a constant for any object. As shown above, when the get methods, such as get name method, get user ID method, get full name method, get telephone method, get office location method, and get description method, are run, if reasonable values are returned, the JCT may print END_TEST_PASS. Otherwise, END_TEST_FAIL may be printed.

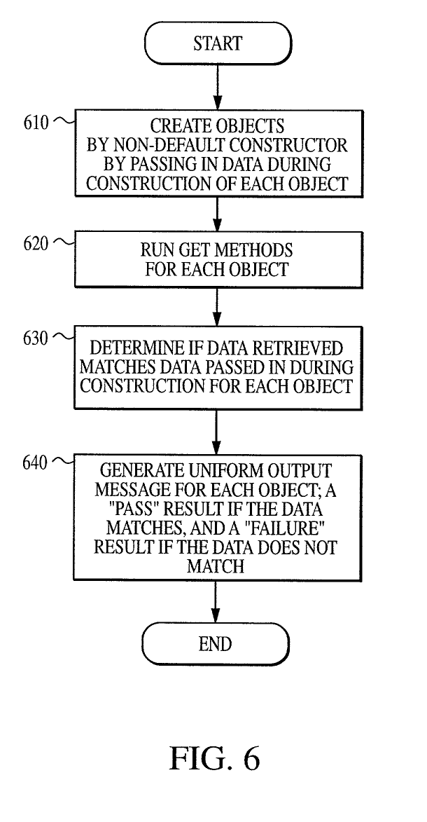

FIG. 6 illustrates a third embodiment of the JCT, involving a non-default constructor that creates objects in a particular fashion. Data may be passed in during construction to instantiate the objects, step 610. For example, a user object constructor may have three parameters, a user name parameter, a user ID parameter, and a comment description parameter. Data passed in may include user names, user IDs, and comment descriptions. Immediately after the data are passed in during object construction, get methods may be run to retrieve the data passed in, step 620, to test if returned data matches the data passed in during construction, step 630. In the example of the user object, a get name method may be run to retrieve the user name passed in, a get user ID method may be run to retrieve the user ID passed in, and a get comment descriptions method may be run to retrieve the comment descriptions passed in. If the user name, the user ID, and the comment descriptions returned by the get methods match the user name, the user ID, and the comment descriptions passed in during construction, the test returns a “pass” result, step 640. Otherwise, the test returns a “failure” result, step 640. The “pass” and “failure” signals may place easily recognizable and standard output in the test log files for future reference.

The following is an example of a source code routine of the JCT illustrated in FIG. 6.

//

**********************************************************************
**

/**

Test the MxUserName class.

**/
//

**********************************************************************
**

public static void testUserName ()
{

MxJctUtility.START_TEST_CASE (“MxUserName”);
String testCase = “Create Valid User Name”;
MxJctUtility.START_TEST (testCase);

try
{

MxUserName userName = new MxUserName (“GoodName”);
MxJctUtility.END_TEST_PASS (testCase);

}
catch (MxException e)
{

MxJctUtility.MESSAGE (e.getMessage ());
MxJctUtility.END_TEST_FAIL (testCase);

}
testCase = “Create Valid User Name with underscore”;
MxJctUtility.START_TEST (testcase);
try
{

MxUserName userName = new MxUserName (“baden_dr”);
MxJctUtility.END_TEST_PASS (testCase);

}
catch (MxException e)
{

MxJctUtility.MESSAGE (e.getMessage ());
MxJctUtility.END_TEST_FAIL (testCase);

}
testCase = “Create Valid User Name with dash”;
MxJctUtility.START_TEST (testCase);
try
{

MxUserName userName = new MxUserName (“baden-dr”);
MxJctUtility.END_TEST_PASS (testCase);

}
catch (MxException e)
{

MxJctUtility.MESSAGE (e.getMessage ());
MxJctUtility.END_TEST_FAIL (testCase);

}
testCase = “Create Invalid Long User Name”;
MxJctUtility.START_TEST (testCase);
try
{

MxUserName userName = new MxUserName (“VeryLongName”);
MxJctUtility.END_TEST_FAIL (testCase);

}
catch (MxException e)
{

MxJctUtility.MESSAGE (e.getMessage ());
MxJctUtility.END_TEST_PASS (testCase);

}
testCase = “Create Valid User Name with underscore”;
MxJctUtility.START_TEST (testCase);
try
{

MxUserName goodName = new MxUserName (“Ok_Name”);
MxJctUtility.END_TEST_PASS (testCase);

}
catch (MxException e)
{

MxJctUtility.MESSAGE (e.getMessage ());
MxJctUtility.END_TEST_FAIL (testCase);

}

}

The above sample code illustrates how non-default objects are tested. If the name passed in during construction is a “GoodName,” a get name method may return the correct name that is passed in, and the JCT may print END_TEST_PASS. If the name passed in during construction is a invalid “VeryLongName,” a get name method may not return the name that is passed in, and the JCT may print END_TEST_FAIL.

For more complex non-default objects that execute commands, such as a user manager object, static methods that are constant for all objects, such as get default manager methods, may be created and run. For a single non-default object, there may be a number of static methods. For example, for the user manager object, there may be methods that, for example, add new objects to the repository 104, delete objects from the repository 104, modify objects in the repository 104, list objects in the repository 104, or list the names of the objects in the repository 104.

To test the functionality of the user manager object, the JCT may first populate the user manager object with a number of user objects so that there is a unit JCT for each of the user objects. Unit JCTs may be installed at the lowest level and built up along the classes. The basic strategy, again, may be to ensure that whatever returned matches what is passed in.

In the example of the user manager object, after the user objects are constructed and installed in the user manager object by a put method, a list name method may be run to list all the names of known users. If five names have been passed in, for example, five names should be listed to indicate that the task works. Next, a list object method may be run to return the actual objects. If the actual objects returned match the objects passed in, the JCT returns a “pass”. Next, a delete method may be run to delete one name, and the list name method may be run to test if the name has been deleted. If the name deleted is the right one, the user manager object is proven to work properly. These steps may be repeated for all the unit JCTs along the user manager class.

Similarly, the same strategy may be adopted for other SCM manager classes, such as the tool manager class, the role manager class, the node manager class, the node group manager class, and other classes, which may also interact with each other.

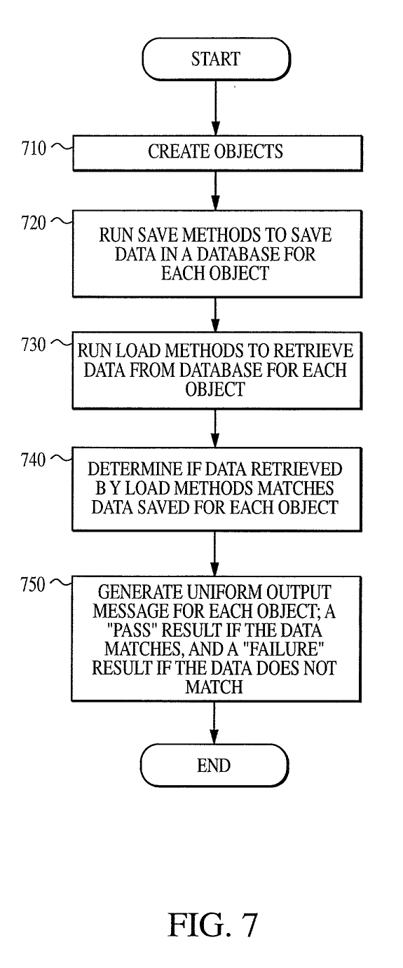

FIG. 7 illustrates a forth embodiment of the JCT. After objects are created, step 710, data in the objects maybe saved in a database by running save methods, step 720. Load methods may then be run to retrieve data from the database, step 730, to test if whatever loaded back matches the data saved, step 740. If the data matches, the JCT returns a “pass” result, step 750. Otherwise, the JCT returns a “failure” result, step 750. The “pass” and “failure” signals may place easily recognizable and standard output in the test log files for future reference.

An output method, such as MxJctUtility, may be utilized to ensure that actual text of messages generated from any method are standard output messages. The following is an example of a JCTUtility.Java source code for generating standard test output:

package com.hp.mx.utilities;
public class MxJctUtility
{

public static void START_TEST_CASE
(
String msg
)
{

System.out.println(“\t” + msg + “ test case starting”);

}
public static void END_TEST_CASE
(
String msg
)
{

System.out.println(“\t” + msg + “ test case done”);

}
public static void START_TEST
(
String msg
)
{

System.out.println(“\t\t” + msg + “ test -- STARTING”);

}
public static void END_TEST_PASS
(
String msg
)
{

System.out.println(“\t\t” + msg + “ test -- PASSED”);

}
public static void END_TEST_FAIL
(
String msg
)
{

System.out.println(“\t\t” + msg + “ test -- FAILED”);

}
public static void MESSAGE
(
String msg
)
{

System.out.println(“\t\t” + msg);

}

}

While the present invention has been described in connection with an exemplary embodiment, it will be understood that many modifications in light of these teachings will be readily apparent to those skilled in the art, and this application is intended to cover any variations thereof.

What is claimed is:

1. A method for object class testing, comprising:
constructing objects from a plurality of classes;
developing a unit class test for the objects; and
testing each object using the unit class test to determine if the object is functional.

2. The method of claim 1, further comprising generating standard output messages for each object based upon the testing step.

3. The method of claim 1, wherein the testing step includes:
passing data into each object using the unit class test; and
retrieving data from each object using the unit class test to determine if the object is functional.

4. The method of claim 3, wherein the passing step includes passing data into each object during object construction.

5. The method of claim 3, wherein the passing step includes passing data into each object by a set method.

6. The method of claim 3, wherein the retrieving step includes retrieving data from each object by a get method.

7. The method of claim 3, wherein the constructing step includes constructing default objects, and the retrieving step includes determining if the data retrieved is a reasonable value.

8. The method of claim 3, wherein the constructing step includes constructing non-default objects, and the retrieving step includes determining if the data retrieved matches the data passed in for each object.

9. The method of claim 1, wherein the testing step includes:
saving data into a database for each object using the unit class test; and
loading data from the database for each object using the unit class test to determine if the object is functional.

10. The method of claim 9, wherein the loading step includes determining if the data loaded matches the data saved into the database.

11. An apparatus for object class testing, comprising:
a module for constructing objects from a plurality of classes;
a module for developing a unit class test for the objects;
a module for passing data into each object using the unit class test; and
a module for retrieving data from each object using the unit class test to determine if the object is functional.

12. The apparatus of claim 11, further comprising a module for generating standard output messages for each object based upon a result of the unit class test.

13. The apparatus of claim 11, wherein the module for passing the data includes a module for passing the data into each object during object construction.

14. The apparatus of claim 11, wherein the module for passing the data includes a set method.

15. The apparatus of claim 11, wherein the module for retrieving the data includes a get method.

16. The apparatus of claim 11, wherein the module for constructing the objects includes a module for constructing default objects, and the module for retrieving the data includes a module for determining if the data retrieved is a reasonable value.

17. The apparatus of claim 11, wherein the module for constructing the objects includes a module for constructing non-default objects, and the module for retrieving the data includes a module for determining if the data retrieved matches the data passed in for each object.

18. A method for object class testing, comprising:
constructing objects from a plurality of classes;
developing a unit class test for the objects;
passing data into each object using the unit class test;
retrieving data from each object using the unit class test to determine if the object is functional; and
generating standard output messages for each object based upon the passing and retrieving steps.

19. The method of claim 18, wherein the constructing step includes constructing default objects, and the retrieving step includes determining if the data retrieved is a reasonable value.

20. The method of claim 18, wherein the constructing step includes constructing non-default objects, and the retrieving step includes determining if the data retrieved matches the data passed in for each object.
